(19) United States
(12) Patent Application Publication
(10) Pub. No.: US 2024/0027409 A1
(43) Pub. Date: Jan. 25, 2024

(54) GAS FLOW NEBULIZER

(71) Applicant: PERKINELMER SCIENTIFIC CANADA ULC, Woodbridge (CA)

(72) Inventor: Charles Jolliffe, Woodbridge (CA)

(21) Appl. No.: 17/871,393

(22) Filed: Jul. 22, 2022

(51) Int. Cl. G01N 30/72; G01N 30/84; G01N 27/623

(52) U.S. Cl. CPC G01N 30/7246; G01N 30/84; G01N 27/623; G01N 2030/847

(57) ABSTRACT

A nebulizer includes a gas transport conduit having a gas inlet for receiving a nebulizer gas and an outlet, the gas transport conduit defining a longitudinal axis along flow direction of the nebulizer gas; and an analyte supply conduit extending into the gas transport conduit along the longitudinal axis, the analyte supply conduit having at least one side aperture configured to emit analyte from the analyte supply conduit into the gas transport conduit in a direction off-axis from the longitudinal axis of the gas transport conduit.

### FIELD

The present disclosure relates to a gas flow nebulizer, and in particular, to a gas flow nebulizer for providing ions to a downstream mass analyzer.

### BACKGROUND

Mass analysis/spectrometry relies on a supply of ionized analyte to a downstream mass analyzer. Ionized analyte may be supplied by an ionizer that transforms non-ionized analyte-often in solvent-into gas phase ions.

Downstream, ions may be separated based on their mass to charge ratio, typically by accelerating them and subjecting them to an electric or magnetic field. This allows for the detection and analysis of a variety of chemical samples. Mass-spectrometry has found a wide variety of applications—and may be used in the detection of unknown compounds, or the identification of known compounds.

Known ionization techniques include electron impact (EI); atmospheric pressure chemical ionization (APCI); electrospray ionization (ESI); atmospheric pressure photoionization (APPI); and matrix assisted laser desorption ionization (MALDI).

U.S. Pat. No. 10,658,168 discloses an ionizer including a probe having coaxially aligned conduits that may carry liquids and nebulizing and heating gases at various flow rates and temperatures for generating ions from a liquid source. An outermost conduit defines an entrainment region that transports and entrains ions in a gas. Depending on the voltages applied to the multiple conduits and electrodes, the ionizer can act as an electrospray, APCI, or APPI source. Further, the ionizer may include a source of photons or a source of corona ionization. Formed ions may be provided to a downstream mass analyzer.

### SUMMARY OF SOME EMBODIMENTS

According to some embodiments, a nebulizer includes a gas transport conduit having a gas inlet for receiving a nebulizer gas and an outlet, the gas transport conduit defining a longitudinal axis along flow direction of the nebulizer gas, and an analyte supply conduit extending into the gas transport conduit along the longitudinal axis, the analyte supply conduit having at least one side aperture configured to emit analyte from the analyte supply conduit into the gas transport conduit in a direction off-axis from the longitudinal axis of the gas transport conduit.

In some embodiments, the at least one side aperture of the analyte supply conduit is configured to emit the analyte in a direction substantially perpendicular to a flow direction of the nebulizer gas in the gas transport conduit.

In some embodiments, the at least one side aperture of the analyte supply conduit is upstream of the outlet of said gas transport conduit.

In some embodiments, the at least one side aperture of the analyte supply conduit is configured to emit the solvated analyte at an acute angle with respect to a flow direction of the nebulizer gas in the gas transport conduit.

In some embodiments, the analyte supply conduit has an analyte inlet configured to receive the analyte from an analyte supply source.

In some embodiments, the analyte inlet is at a first end of the analyte supply conduit, the analyte supply conduit having a closed second end that is opposite the first end. In some embodiments, the analyte inlet is at the first end of the analyte supply conduit, and the analyte supply conduit has an open second end that is opposite the first end. The open second end may be further configured to emit the analyte in addition to the at least one side aperture.

In some embodiments, the closed second end comprises a dome extending away from the analyte supply conduit.

In some embodiments, the at least one side aperture is configured to emit solvated analyte from the analyte supply conduit into the gas transport conduit.

In some embodiments, the at least one side aperture comprises a coating configured to reduce liquid wetting on a surface of the analyte supply conduit.

In some embodiments, the at least one side aperture comprises at least two side apertures on opposing sides of the analyte supply conduit.

In some embodiments, the at least two side apertures comprise a first and second aperture, the first aperture being offset from the second aperture along an axis of the analyte supply conduit.

In some embodiments, the gas transport conduit comprises a nebulizer gas transport conduit, the nebulizer further comprising an outer gas transport conduit, wherein the nebulizer gas transport conduit extends into the outer gas transport conduit, the outer gas transport conduit having an outer gas inlet and an outer gas outlet configured to deliver a gas to a mass analyzer.

In some embodiments, the analyte comprises a solvated analyte that is received by the analyte supply conduit from an analyte source.

In some embodiments, wherein the mass analyzer comprises a quadrupole mass spectrometer.

According to some embodiments, methods of generating analyte ions include flowing a nebulizer gas along a gas transport conduit having an inlet for receiving the nebulizer gas and an outlet, the gas transport conduit defining a longitudinal axis along flow direction of the nebulizer gas; and flowing an analyte along an analyte supply conduit extending into the gas transport conduit along the longitudinal axis, the analyte supply conduit having at least one side aperture, wherein the analyte is emitted from the analyte supply conduit into the gas transport conduit in a direction off-axis from the longitudinal axis of the gas transport conduit.

In some embodiments, the method includes emitting the analyte in a direction substantially perpendicular to a flow direction of the nebulizer gas.

In some embodiments, the at least one side aperture of the analyte supply conduit is upstream of the outlet of said gas transport conduit.

In some embodiments, the method includes emitting the analyte at an acute angle with respect to a flow direction of the nebulizer gas in the gas transport conduit. In some embodiments, the analyte supply conduit has an analyte inlet configured to receive the analyte from an analyte supply source. In some embodiments, the analyte inlet is at a first end of the analyte supply conduit, the analyte supply conduit having a closed second end that is opposite the first end. In some embodiments, the closed second end comprises a dome extending away from the analyte supply conduit.

In some embodiments, the at least one side aperture is configured to emit solvated analyte from the analyte supply conduit into the gas transport conduit.

In some embodiments, the at least one side aperture comprises a coating configured to reduce liquid wetting on a surface of the analyte supply conduit.

In some embodiments, the at least one side aperture comprises at least two side apertures on opposing sides of the analyte supply conduit.

In some embodiments, the at least two side apertures comprise a first and second aperture, the first aperture being offset from the second aperture along an axis of the analyte supply conduit.

In some embodiments, the gas transport conduit comprises a nebulizer gas transport conduit, and an outer gas transport conduit configured so that the nebulizer gas transport conduit extends into the outer gas transport conduit, the method further comprising delivering a gas to a mass analyzer via an outlet of the outer gas transport conduit.

In some embodiments, the analyte comprises a solvated analyte that is received by the analyte supply conduit from an analyte source.

In some embodiments, the mass analyzer comprises a quadrupole mass spectrometer.

### BRIEF DESCRIPTION OF THE DRAWINGS

The accompanying drawings, which are incorporated in and constitute a part of the specification, illustrate some embodiments and, together with the description, serve to explain principles of the disclosure.

FIG. 1 is a schematic diagram of a nebulizer system according to some embodiments.

FIG. 2 is a cross sectional view of the gas transport conduits of the nebulizer system of FIG. 1.

FIG. 3 is a side view of a configuration of apertures in a gas transport conduit according to some embodiments.

FIG. 4 is a schematic view of a nebulizer with a closed end according to some embodiments.

FIG. 5 is a schematic view of a nebulizer that directs nebulized gas toward a mass analyzer according to some embodiments.

FIG. 6 is a schematic view of a nebulizer with a domed and flared distal end according to some embodiments.

FIG. 7 is a schematic view of a nebulizer with a domed distal end according to some embodiments.

FIG. 8 is a schematic view of a nebulizer that directs sample analyte at an acute angle with respect to the flow direction in the conduit according to some embodiments.

FIG. 9 is a schematic view of a nebulizer with focusing elements according to some embodiments.

FIG. 10 is a schematic view of a nebulizer with focusing elements according to some embodiments.

### DETAILED DESCRIPTION

The inventors have recognized and appreciated that, in a gas flow ionizer for providing ions for mass analysis, there is a need for greater sensitivity.

The inventors have further recognized and appreciated that, in a nebulizer for providing ions for mass analysis, greater sensitivity may be achieved if the nebulized sample droplet size and/or the width of the droplet size spatial distribution is reduced.

The inventors have further recognized an appreciated, that the droplet size may be reduced, and the sensitivity of a nebulizer may be increased by changing a direction of the sample analyte exiting an analyte supply conduit as the sample analyte enters a flow stream of a supply gas.

Embodiments according to the inventive concept may in combination with various ionization techniques. For example, in electrospray ionization (ESI), an analyte is typically ionized in solution due to pH alteration with acids. The isoelectric point is the pH at which a molecule carries no net electrical charge or is electrically neutral in the statistical mean. The analyte may be ionized in solution due to pH alteration with acids. Therefore, it should be understood that droplet charging as described herein may ionize the analyte or the analyte may already be ionized. In some embodiments, droplet charging may assist with the droplet desolvation.

The shear spray techniques described herein may also be used for APCI, where the analyte is not ionized in solution and there is no isoelectric effect, but instead atmospheric chemical ionization is used, typically by corona discharge.

FIG. 1 illustrates an example nebulizer 14, including a probe 10 that is configured to provide a nebulized analyte that is ionized and analyzed by a downstream mass analyzer 12.

The probe 10 includes nested conduits or tubes: an innermost analyte supply conduit 20, an inner gas transport conduit 22, and an outer gas transport conduit 24. The nebulizer 14 further includes a housing 26 that interconnects the probe 10 to the downstream mass analyzer 12. An optional electrode 62 and optional photo-ionizer 60 may be contained within housing 26. Each of the conduits 20, 22 and 24 may be formed of conductive material. The nebulized analyte from the probe 10 may be evaporated to form gas phase analyte molecules, which are chemically ionized by reagent ions, for example, provided by the photo-ionizer 60, and steered toward an inlet 34 of the mass analyzer 12 by the electrode.

The inner gas transport conduit 22 carries a first supply gas G1. The outer gas transport conduit carries a second supply gas G2. The first and second gases G1, G2 may be nitrogen and may be provided at different temperatures and pressures.

As illustrated in FIG. 1, the innermost analyte supply conduit 20 has at least one side aperture 30 that is configured to emit analyte from the analyte supply conduit 20 into the innermost analyte supply conduit 20 in a direction that is off-axis from the longitudinal axis of the gas transport conduit. Thus, the side aperture(s) 30 provides solvated analyte in droplets into the inner gas transport conduit 22. The conduit 24 extends a defined distance beyond the end of the innermost analyte supply conduit 20. Solvated analyte may flow from a source of solvated analyte (not shown) via an inlet to the analyte supply conduit 20 of the nebulizer 14 and exit the side aperture 30 of the analyte supply conduit 20 into the flow of the first supply gas G1 in the inner gas transport conduit.

In some embodiments, the apertures 30 may include four apertures that are positioned an equal distance from one another around the circumference of the conduit 20, i.e., at 90° from one another. In this configuration, the first supply gas G1 is a nebulizer gas that is received at the inlet of the inner gas transport conduit 22, and the flow of the first supply gas G1 is also orthogonal to the liquid flow out of the side apertures. Without wishing to be bound by any particular theory, as the liquid sample emerges from the apertures 30, liquid nebulization may occur by the shearing effect of the first supply gas, which may be provided at a high velocity. Annular flow occurs in the inner gas transport conduit 22 of the first supply gas G1 (e.g., the nebulizer gas) and the nebulized analyte. In this configuration, the droplet diameter distribution may be reduced and narrowed as compared to a droplet distribution in a nebulizer or gas ionizer in which the analyte exits a tip portion of the analyte supply conduit 20 in the same direction, e.g., on-axis, with a direction of the first supply gas G1. In some embodiments, the analyte supply conduit 20 is configured to emit the analyte or analyte droplets in a direction that is substantially perpendicular to the flow direction of the nebulizer gas (i.e., the first supply gas G1) in the inner gas transport conduit 22. “Substantially perpendicular” means between 85 and 95 degrees, and preferably between 89 and 91 degrees.

With reference to FIG. 1, the analyte exits the side apertures 30 of the innermost analyte supply conduit 20 and is carried by the first supply gas G1 in the inner gas transport conduit 22. The analyte exits the inner gas transport conduit 22 at an outlet thereof and is entrained and desolvated by the transport gas G2 in the outer conduit 24 in some examples, the temperature of the transport gas G2 may be higher than the temperature of the first supply gas G1, aiding in the desolvation of the analyte. In some embodiments, a distance between the outlet of the inner gas transport conduit 22 and the outlet 28 of the outer gas transport conduit 24 is about one to three centimeters; however, any suitable distance may be used, such as between one and ten centimeters. The distance from the outlet of the inner gas transport conduit 22 and the outlet 28 is configured to allow the transport gas G2 in the outer conduit 24 to entrain and desolvate ions, which can provide enhanced sensitivity and stability of the generated source of ions.

One or more voltage source(s) 50 may apply relative potentials to conduits 20, 22, 24. For purposes of explanation, the sources 50 applies potential V_{A} to conduit 22, V_{B} to conduit 20; V_{C} to conduit 24, V_{D} to the housing 26, V_{E} to the electrode 62, VF to the inlet V_{C} 34 of the mass analyzer 12, and VG to the photo-ionizer 60. Example relationships of V_{A} to VG are described, for example, in U.S. Pat. No. 10,658,168, the disclosure of which is hereby incorporated by reference in its entirety.

The probe 10 may also be configured such that the conduits 20, 22, 24, or the probe 10 may have positions that are independently adjusted relative to the inlet 34 of the downstream mass analyzer 12. In addition, the conduits 20, 22 may be moved along the z axis, relative to outer conduit 24, which may improve sensitivity and signal stability.

For example, concentrations of analyte in solution in ranges from below 1 femtogram per μL solvent to above 1 microgram per μL solvent may be introduced through inner coaxial conduit 22 via the side aperture 30 of the analyte supply conduit 20. Solvents may include a water and acetonitrile mix (mixed, for example, at a 50:50 or 30:70 ratio) to promote ion formation and liberation. The solvent may be further adjusted with formic acid and ammonium acetate, such as 0.1% formic acid and 2 mM ammonium acetate, although the exact amount may be varied.

As illustrated, the inlet 34 of the mass spectrometer 12 is about 90 degrees from the flow direction of the nebulized gas from the outlet 28 of the nebulizer. In some embodiments, the inlet 34 is at the tip of a sampling cone of the mass analyzer 12.

The gases G1 and G2 may be maintained at a temperature between about 30 and 700° C., but lower temperatures may be possible. Typical temperature rages are between 250° C. and 700° C., but higher temperatures may be possible.

The gas G1 exits the inner gas transport conduit 22 and enters outer gas transport conduit 24, which transports analyte ions entrained in the gas G2 to the exit 28 of the conduit 24. The gas G2 mixes with the gas G1 in the outer gas transport conduit 24 and transports entrained ionized analyte from the gas transport conduit 24, into the nebulizer housing 26.

The housing 26 houses at least the end of the probe 10 and provides an enclosure to maintain a suitable environment for transport and guiding of ionized analyte to downstream stages of a mass analyzer 12. In some embodiments, ions are guided by way of an electric field, between the exit 28 of the conduit 24, and the inlet 34 of the downstream elements of the mass analyzer 12. Additional electrodes (not shown) with the housing 26 may be used to further aid in guiding ions to inlet 34. The housing 26 may be formed of a conductive material. The interior of the housing 26 may be maintained at about atmospheric pressure, although higher pressures (e.g. between up to 100 torr to 2000 torr) and lower pressures are possible. The housing 26 may be evacuated by an evacuation pump (not shown).

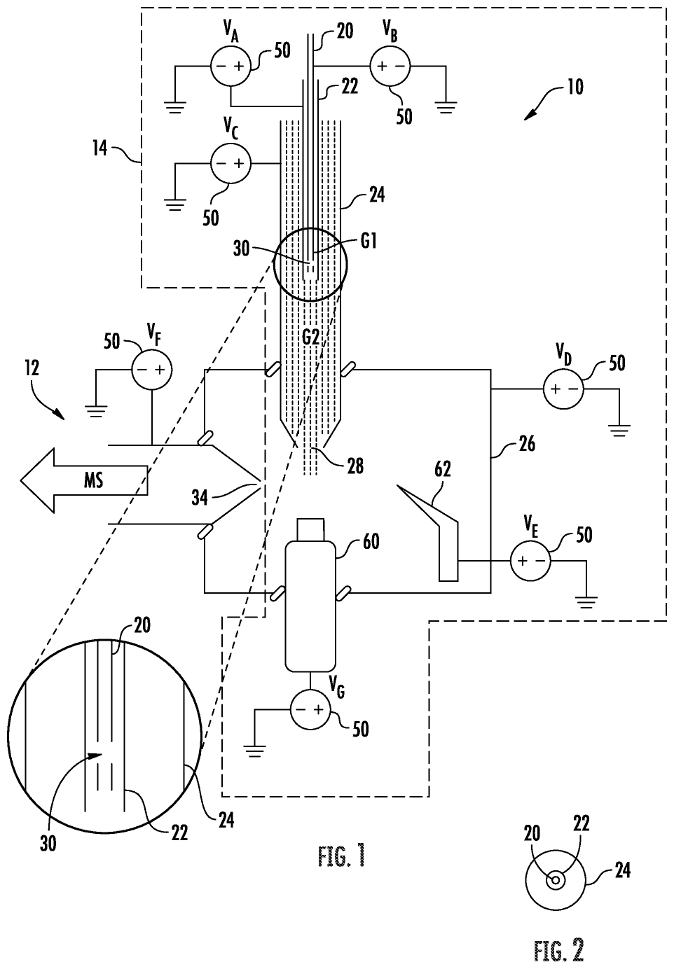

The nested conduits 20, 22 and 24 may be co-axial to each other, and generally cylindrical in shape as shown in the example of FIG. 2. Each of conduits 20, 22 and 24 may be formed of a conductive or insulating material. In some embodiments, the conduits 20, 22, 24 may be conductive-formed of a metal or metal alloy-such as aluminum, stainless steel, or the like. However, any suitable conduit geometry or material may be used as would be understood by one of skill in the art.

The nebulizer 14 may form part of the mass analyzer 12 or be separate therefrom. Mass analyzer 12 may take the form of a conventional mass analyzer, and may, for example, be a quadrupole mass spectrometer as disclosed in U.S. Pat. Nos. 7,569,811 and 9,343,280, the contents of which are hereby incorporated by reference.

It should be understood that any number of apertures 30 may be used, such as 2, 4, 5, 6, 7, 8, or as many as 10, 12, 14, 16 or more apertures. In addition, although the apertures 30 are illustrated in FIG. 1 as being at a same distance along the length of the analyte supply conduit 20, as shown in FIG. 3, the apertures may be offset or positioned at different distances spaced apart along the length of the analyte supply conduit 20. The apertures 30 may include at least two side apertures on opposing sides of the analyte supply conduit 20 at a same distance or at different distances along the length of the analyte supply conduit. The conduit 20 may have a distal end that is closed by a barrier 20A to prevent sample analyte from exiting the conduit 20 out of the distal end so that essentially all of the sample analyte exits the conduit 20 from the side apertures 30. However, in some embodiments, the barrier 20A is omitted. Thus, the analyte supply conduit 20 has an open end that may be further configured to emit the analyte in addition emitting the analyte by the at least one side apertures 30. The side apertures 30 are further illustrated as providing exits that are orthogonal to the longitudinal axis of the analyte supply conduit; however, other angles may be used. For example, the apertures 30 may include a flow channel that is at an acute angle with respect to the longitudinal axis of the analyte supply conduit. In some embodiments, the distal end may include at least one axial aperture (not shown) in addition to one or more side apertures.

In some embodiments, the side aperture(s) 30 include a coating configured to reduce liquid wetting on a surface of the analyte supply conduit, such as a functionalized hydrogenated amorphous silicon coating (available under the trademarks SilcoNert® 2000 Sulfinert®, and Siltek® from SilcoTec, 225 Penntech Dr, Bellefonte, PA 16823, U.S.A.).

In some embodiments, the second supply gas G2 in the conduit 24 may be a heating gas for heating the nebulized sample in first supply gas G1 after the sample analyte has exited the conduit 20. As illustrated, the apertures 30 are upstream of the outlet of the conduit 22; however, the apertures may be downstream of the outlet of the conduit 22. Moreover, in some embodiments, the second supply gas G2 and the outer conduit 24 may be omitted, and the first supply gas G1 in the conduit 22 may be sufficient to nebulize and/or heat the sample analyte.

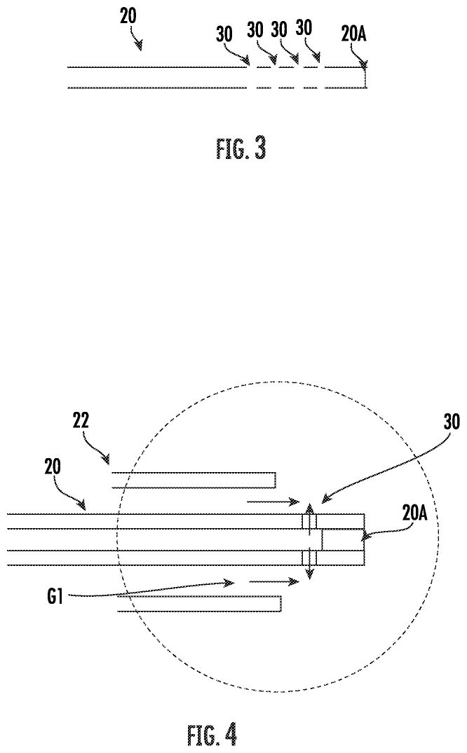

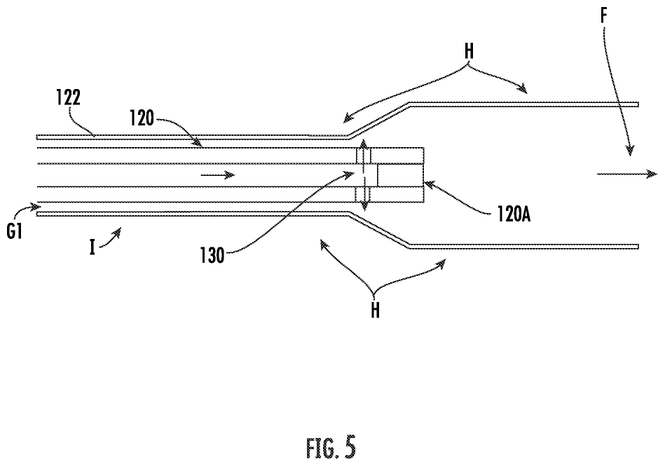

For example, as illustrated in FIG. 4, a heated supply gas G1 is provided in the conduit 22 and the sample analyte exits side apertures 30 in the conduit 20. The sample analyte is prevented from exiting the end of the conduit 20 by the barrier 20A. In this configuration, nebulized sample analyte may exit the side apertures 30 and be nebulized and desolvated by the gas G1 and subsequently provided to a mass analyzer. Moreover, the apertures 30 may be exterior to the conduit 22 as shown in FIG. 4. In addition, the blocked top or barrier 20A of the conduit 20 may have a shape, such as a dome shape, to reduce the electric field at the end of the conduit 20 to reduce the possibility of forming a corona. In addition, the apertures 30 may be coated to reduce liquid accumulation or wetting on its surface, e.g., to improve liquid removal by gas nebulization.

Accordingly, as liquid analyte exits the side apertures described herein, it is torn into droplets or nebulized by a nebulizer gas (e.g., G1 in the conduit 22). The liquid may be further charged by a high electric field, which may further facilitate droplet desolvation. The desolvating charged droplet and gas mixture may then be directed toward the mass spectrometer. Desolvated ions and mostly desolvated ions are attracted by electric fields generated by voltages on, for example, a curtain cap and/or sampling orifice of the mass spectrometer through a counter flowing curtain gas. The curtain gas assists in maintaining mass spectrometer cleanliness by reducing the solvent molecules or contaminants that could enter the mass spectrometer. The nebulized sample analyte may then enter the mass spectrometer through a sampling cone, such as the inlet 34 of the mass analyzer 12 (FIG. 1). The nebulization of the liquid sample may also be increased by an electric field created by a voltage difference between the sample conduit 20 and the inlet 34 or other conductive elements. As illustrated in FIG. 5, a sample analyte conduit 120 includes an end barrier 120A and side apertures 130 through which the sample analyte exits the conduit 120. The nebulizer or supply gas G1 is provided in the conduit 122. The nebulized gas flows in a flow direction F toward the mass analyzer, which may include a curtain gas. The conduit 122 further includes an insulated portion I and a heated portion H. The heated portion H is configured to heat the nebulizer or supply gas G1. In some embodiments, the heated portion H may be electrically conducting so that a voltage difference between the heated portion H and the liquid sample analyte may be generated.

In particular embodiments, the flow F may be in an environment that has a pressure that is reduced so that the droplets and nebulizer gas flow directly into a lower pressure region leading to a mass analyzer.

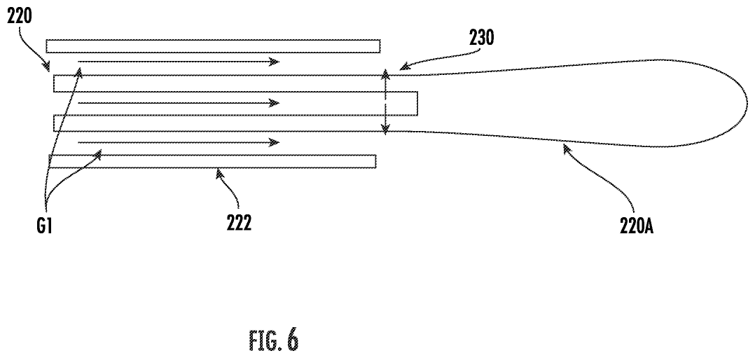

In some embodiments, the distal end of the sample analyte conduit may be sized and configured to direct a flow of the nebulized gas. For example, as illustrated in FIG. 6, the nebulizer includes a sample analyte conduit 220 and the nebulizer or supply gas G1 flowing through the gas conduit 222. The sample analyte conduit 220 has a closed distal end 220A that is distal to and downstream from the side apertures 230 and has a diameter that is larger than the diameter of the sample analyte conduit 220. In this configuration and without wishing to be bound by any particular theory, it is currently believed that the Coanda effect may cause the flow of nebulized analyte to curve around the surface of the distal end 220A. The flow direction may be focused at a distance downstream from the distal end 220A to direct the nebulized gas flow, e.g., toward the mass analyzer.

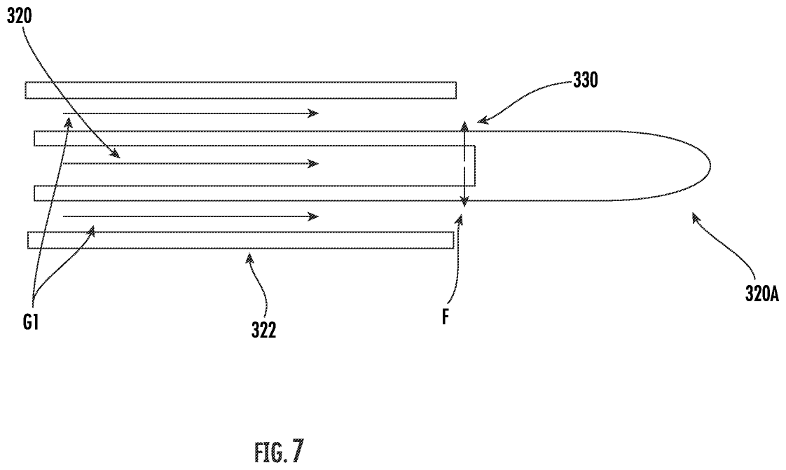

Although the distal end 220A of the sample analyte conduit 220 is illustrated as having a diameter that is larger than the diameter of the conduit 220, it should be understood that any suitable diameter and shape may be used to provide a desired flow of the nebulized gas. As illustrated in FIG. 7, the nebulizer includes a sample analyte conduit 320 and the nebulizer or supply gas G1 flowing through the gas conduit 322. The sample analyte conduit 320 has a closed distal end 320A that is distal to and downstream from the side apertures 330 and has a diameter that is approximately the same as the diameter of the sample analyte conduit 220. The ends 220A and 320A have a curved tip that may facilitate the direction of nebulized gas flow toward the mass analyzer.

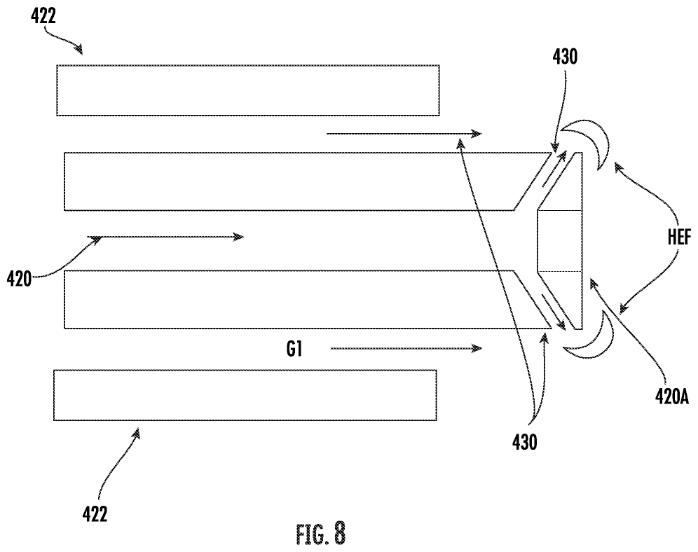

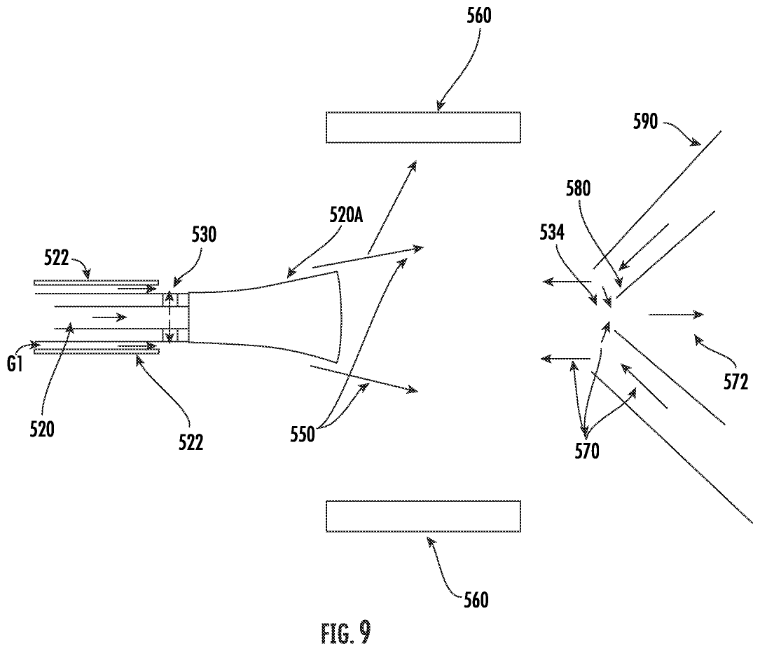

In some embodiments, the exiting angle at which the sample analyte exits the sample analyte conduit may be about ninety degrees as illustrated in FIGS. 2-7. However, any suitable angle may be used, and in particular, acute angles (i.e., less than 90 degrees with respect to the flow direction of the nebulizer gas) may be used. As illustrated in FIG. 8, the nebulizer includes a sample analyte conduit 420 and the nebulizer or supply gas G1 flowing through the gas conduit 422. The sample analyte conduit 420 has a closed distal end 420A that is distal to and downstream from the side apertures 430 adjacent an optional high electric field HEF. The side apertures 430 are at an acute angle with respect to the longitudinal axis of the sample analyte conduit 420 and the flow direction of the nebulizing gas G1. The high electric field HEF may be generated by an applied voltage difference between elements of the nebulizer. For example, the high electric field HEF may be generated by an applied voltage difference between the sample analyte conduit 420 and another conductor spaced apart from the conduit 420. The high electric field HEF may be omitted; however, the high electric field HEF may be greater at the end of the cylinder and provide droplet charging for desolvation through Coulombic repulsion. Although the high electric field HEF is illustrated in FIG. 8 with respect to side apertures 430 having an acute angle, the high electric field HEF may be used with side apertures at a ninety-degree angle, e.g., as illustrated in FIGS. 2-7.

In some embodiments, additional focusing or directing elements may be used to direct the nebulized ion flow to the mass spectrometer. As illustrated in FIG. 9, the nebulizer includes a sample analyte conduit 520 and the nebulizer or supply gas G1 flowing through the gas conduit 522. The sample analyte conduit 520 has a closed distal end 520A that is downstream from the side apertures 530 and is shaped to direct a gas flow direction 550 away from the end 520A. The end 520A is flared with a “trumpet-shape” that increases in diameter as the end 520A extends away from the conduit 520. Lens elements 560 are conductive elements that may be electrically charged to create a voltage difference between the end 520A and further direct and focus the nebulized ion flow direction 550 towards an inlet 534 of a mass spectrometer sampling cone 580. A curtain cap 590 surrounds the sampling cone 580 and directs a curtain gas 570 around the inlet 534 such that a mixture of the ionized sample gas and the curtain gas flows toward the mass spectrometer as indicated by arrow 572.

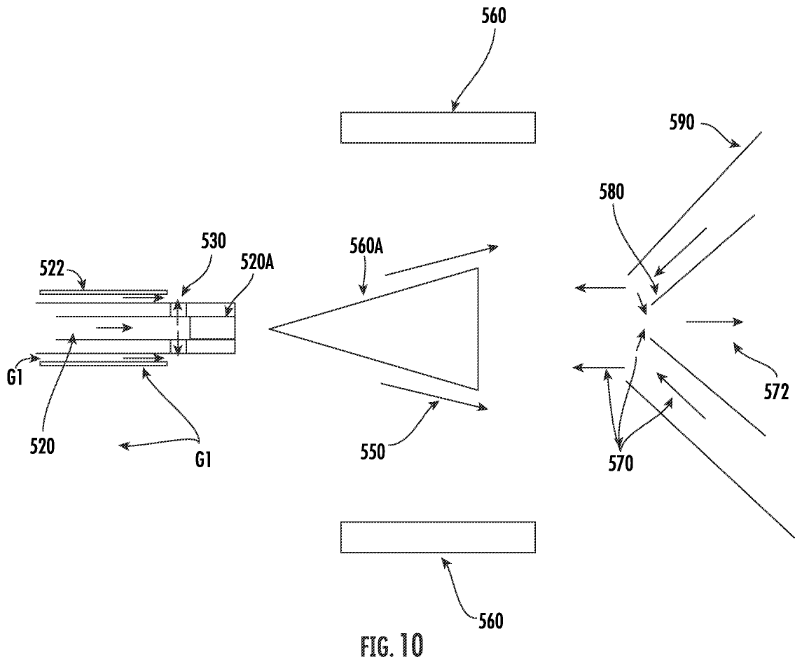

It should be understood that the mass spectrometer inlet may be at any suitable angle with respect to the gas flow direction. For example, in FIG. 1, the inlet 34 is at a ninety-degree angle from the flow direction of the nebulized gas, and in FIG. 9, the inlet 534 is not offset from the flow direction. Moreover, it should be understood that any suitable focusing elements may be used. As illustrated, for example, in FIG. 10, an additional focusing element 560A is provided as a separated element from the end 520A.

In some embodiments, the mass analyzer may be kept clean by using various techniques, including those described in U.S. Pat. No. 9,916,969, the disclosure of which is incorporated by reference in its entirety.

The present inventive concepts are described herein with reference to the accompanying drawings and examples, in which embodiments are shown. Additional embodiments may take on many different forms and should not be construed as limited to the embodiments set forth herein. Rather, these embodiments are provided so that this disclosure will be thorough and complete, and will fully convey the scope of the inventive concepts to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting thereof. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on,” “attached” to, “connected” to, “coupled” with, “contacting,” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is inverted, elements described as “under” or “beneath” other elements or features would then be oriented “over” the other elements or features. Thus, for example, the term “under” can encompass both an orientation of “over” and “under.” The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

It will be understood that, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present disclosure. The sequence of operations (or steps) is not limited to the order presented in the claims or figures unless specifically indicated otherwise.

The foregoing is illustrative of the present inventive concept and is not to be construed as limiting thereof. Although a few example embodiments have been described, those skilled in the art will readily appreciate that many modifications are possible in the example embodiments without materially departing from the novel teachings of this inventive concept. Accordingly, all such modifications are intended to be included within the scope of this inventive concept as defined in the claims. Therefore, it is to be understood that the foregoing is illustrative of the present inventive concept and is not to be construed as limited to the specific embodiments disclosed, and that modifications to the disclosed embodiments, as well as other embodiments, are intended to be included within the scope of the appended claims.

What is claimed is:

1. A nebulizer comprising:
a gas transport conduit having a gas inlet for receiving a nebulizer gas and an outlet, the gas transport conduit defining a longitudinal axis along a flow direction of the nebulizer gas; and
an analyte supply conduit extending into the gas transport conduit along the longitudinal axis, the analyte supply conduit having at least one side aperture configured to emit analyte from the analyte supply conduit into the gas transport conduit in a direction off-axis from the longitudinal axis of the gas transport conduit.

2. The nebulizer of claim 1, wherein the at least one side aperture of the analyte supply conduit is configured to emit the analyte in a direction substantially perpendicular to the flow direction of the nebulizer gas in the gas transport conduit.

3. The nebulizer of claim 1, wherein the at least one side aperture of the analyte supply conduit is upstream of the outlet of said gas transport conduit.

4. The nebulizer of claim 1, wherein the at least one side aperture of the analyte supply conduit is configured to emit the analyte at an acute angle with respect to a flow direction of the nebulizer gas in the gas transport conduit.

5. The nebulizer of claim 1, wherein the analyte supply conduit has an analyte inlet configured to receive the analyte from an analyte supply source.

6. The nebulizer of claim 5, wherein the analyte inlet is at a first end of the analyte supply conduit, the analyte supply conduit having a closed second end that is opposite the first end.

7. The nebulizer of claim 6, wherein the closed second end comprises a dome extending away from the analyte supply conduit.

8. The nebulizer of claim 1, wherein the at least one side aperture is configured to emit solvated analyte from the analyte supply conduit into the gas transport conduit.

9. The nebulizer of claim 1, wherein the at least one side aperture comprises a coating configured to reduce liquid wetting on a surface of the analyte supply conduit.

10. The nebulizer of claim 1, wherein the at least one side aperture comprises at least two side apertures on opposing sides of the analyte supply conduit.

11. The nebulizer of claim 8, wherein the at least two side apertures comprise a first and second aperture, the first aperture being offset from the second aperture along an axis of the analyte supply conduit.

12. The nebulizer of claim 1, wherein the gas transport conduit comprises a nebulizer gas transport conduit, the nebulizer further comprising an outer gas transport conduit, wherein the nebulizer gas transport conduit extends into the outer gas transport conduit, the outer gas transport conduit having an outer gas inlet and an outer gas outlet configured to deliver a gas to a mass analyzer.

13. The nebulizer of claim 1, wherein the analyte comprises a solvated analyte that is received by the analyte supply conduit from an analyte source.

14. The nebulizer of claim 12, wherein the mass analyzer comprises a quadrupole mass spectrometer.

15. A method of generating analyte ions, the method comprising:
flowing a nebulizer gas along a gas transport conduit having a gas inlet for receiving the nebulizer gas and an outlet, the gas transport conduit defining a longitudinal axis along a flow direction of the nebulizer gas; and
flowing an analyte along an analyte supply conduit extending into the gas transport conduit along the longitudinal axis, the analyte supply conduit having at least one side aperture, wherein the analyte is emitted from the analyte supply conduit into the gas transport conduit in a direction off-axis from the longitudinal axis of the gas transport conduit.

16. The method of claim 15, further comprising emitting the analyte in a direction substantially perpendicular to the flow direction of the nebulizer gas.

17. The method of claim 15, wherein the at least one side aperture of the analyte supply conduit is upstream of the outlet of said gas transport conduit.

18. The method of claim 15, further comprising emitting the analyte at an acute angle with respect to a flow direction of the nebulizer gas in the gas transport conduit.

19. The method of claim 15, wherein the analyte supply conduit has an analyte inlet configured to receive the analyte from an analyte supply source.

20. The method of claim 19, wherein the analyte inlet is at a first end of the analyte supply conduit, the analyte supply conduit having a closed second end that is opposite the first end.

21. The method of claim 20, wherein the closed second end comprises a dome extending away from the analyte supply conduit.

22. The method of claim 15, wherein the at least one side aperture is configured to emit analyte from the analyte supply conduit into the gas transport conduit.

23. The method of claim 15, wherein the at least one side aperture comprises a coating configured to reduce liquid wetting on a surface of the analyte supply conduit.

24. The method of claim 15, wherein the at least one side aperture comprises at least two side apertures on opposing sides of the analyte supply conduit.

25. The method of claim 24, wherein the at least two side apertures comprise a first and second aperture, the first aperture being offset from the second aperture along an axis of the analyte supply conduit.

26. The method of claim 15, wherein the gas transport conduit comprises a nebulizer gas transport conduit, and an outer gas transport conduit configured so that the nebulizer gas transport conduit extends into the outer gas transport conduit, the method further comprising delivering a gas to a mass analyzer via an outlet of the outer gas transport conduit.

27. The method of claim 15, wherein the analyte comprises a solvated analyte that is received by the analyte supply conduit from an analyte source.

28. The method of claim 26, wherein the mass analyzer comprises a quadrupole mass spectrometer.
